(19) United States
(12) Patent Application Publication
(10) Pub. No.: US 2008/0228889 A1
(43) Pub. Date: Sep. 18, 2008

(54) METHOD, SYSTEM AND COMPUTER PROGRAM PRODUCT FOR DISTRIBUTING SOFTWARE BASED ON AN E-MAIL SERVICE

(75) Inventors: Antonio Secomandi, Brugherio (IT); Marco Secchi, Roma (IT); Luigi Pichetti, Roma (IT)

Correspondence Address: IBM Corporation, (OLP);c/o ORTIZ & LOPEZ, PLLC, P.O. Box 4484, Albuquerque, NM, 87196-4484, US

(73) Assignee: International Business Machines Corporation

(21) Appl. No.: 12/129,077

(22) Filed: May 29, 2008

(30) Foreign Application Priority Data
Dec. 20, 2005 (EP) 05112527.6
Oct. 25, 2006 (EP) PCT/EP2006/067738

(51) Int. Cl. G06F 9/44; G06F 15/16

(52) U.S. Cl. 709/206; 717/172

(57) ABSTRACT

A solution for distributing software products is proposed. Typically, a software distribution infrastructure controls the deployment of software packages to selected endpoints; each software package includes commands and resource images, which are used to install a corresponding software product. For this purpose, an e-mail service is exploited. Particularly, a new e-mail message is created for each software package to be deployed; the software package is embedded into the e-mail message as an attachment and tags for controlling the software distribution process (such as a desired target state of the software package) are inserted into its body section. A plug-in of a mail client on each endpoint receives that e-mail message; the software package is then extracted and passed to an application engine, which controls its application according to the target state indicated by the corresponding control tag.

### PRIORITY TO RELATED PATENT APPLICATION

This patent application claims priority to International Patent Application No. PCT/EP2006/067738, entitled “Method, System and Computer Program Product for Distributing Software Based on an E-mail Service,” which was filed under the Patent Cooperation Treaty (PCT) on Oct. 25, 2006, and claims priority to European Patent Application No. 05112527.6 filed with the European Patent Office on Dec. 20, 2005, said applications expressly incorporated herein by reference in their entireties.

### TECHNICAL FIELD

The present invention relates to the information technology field. More specifically, the invention relates to the distribution of software products in a data-processing system.

### BACKGROUND

The management of software products (such as their installation, removal, upgrade or configuration) is a very time consuming activity, especially in a data processing system including a high number of computers (or endpoints). A typical example is a large network with hundreds of workstations, wherein software products are periodically updated in order to be abreast of the information technology development.

For this purpose, software distribution applications have been proposed in the last years to facilitate the deployment of software products from a central site of the system; an example of commercial software distribution application available on the market is the “IBM Tivoli Configuration Manager or ITCM” by IBM Corporation. Typically, a software distribution application controls the building of software packages including the definition of actions to be carried out on selected endpoints for enforcing the desired software products; each software package further embeds an image of the resources required for its application (such as a compressed copy of the software product to be installed). The software package is distributed to the endpoints and it is then applied (by executing the corresponding actions) so as to reach a desired target state (e.g., installed or removed).

For this purpose, the software distribution applications known in the art exploit a deployment service (such as the “Multiplexed Distribution or MDIST2” service based on the “Tivoli Management Framework or TMF” by IBM Corporation). Typically, the deployment service is implemented by one or more levels of gateways, which act as depots (or repeaters) for the software packages to be distributed

However, this solution is not completely satisfactory. Indeed, the implementation of the deployment service requires the set up of a dedicated infrastructure; therefore, the corresponding investment may not be tenable in some scenarios (e.g., when the software products must be distributed in a small organization).

In any case, the addition of the deployment service increases the complexity to the system. Particularly, this solution requires the installation of further computers implementing the gateways; moreover, the central site and the different endpoints must be correctly configured so as to be associated with the corresponding gateways. Therefore, the maintenance of the infrastructure is quite complex (especially in a highly dynamic environment).

Moreover, the deployment service is quite invasive. Indeed, this service always needs a relatively complex agent on each endpoint (which agent is in charge of periodically verifying the availability of software packages addressed to the endpoint and of controlling their downloading). However, this agent (continuously running in the background) adversely affects the performance of the endpoints; in addition, its installation may not be possible in some specific situations (e.g., when strict security requirements apply).

All of the above hinders the widespread diffusion of the software distribution applications. This has a detrimental impact on the management costs and on the reliability of the data processing systems.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is therefore one aspect of the present invention to provide a new approach for exploiting electronic mail messages for distributing the software packages.

It is, therefore, one aspect of the present invention to provide for an improved data-processing method, system and computer-usable medium.

The aforementioned aspects and other objectives and advantages can now be achieved as described herein. A method, system and/or computer-usable medium are therefore disclosed for distributing software products in a data processing system. The system includes a plurality of target entities (or endpoints), which are reachable through an electronic mail server (or more). The method begins with the step of providing a software package, which is adapted to enforce a set of predefined target states of a software product (such as installed, removed, and the like). A service electronic mail message is delivered through the mail server to a set of target entities; the service message includes the software package and an indication of a selected target state of the corresponding software product. An agent extracts the software package and the indication of the selected target state from the service message on each target entity. The software package can now be applied on each target entity to enforce the selected target state of the software product on the target entity.

In one embodiment of the invention, this result can be achieved by invoking a software distribution engine in response to the selection of an attachment of the service message including the software package (displayed by a mail client).

In another embodiment, all the e-mail messages are intercepted on the endpoint by the above-mentioned agent, which invokes the software distribution engine or passes them to the mail agent according to a result of their introspection.

Preferably, the whole process is controlled by software distribution requests submitted by a corresponding server.

A method to further improve the solution is of supporting the possibility of submitting e-mail messages with specific requests by the endpoints directly to the mail server.

As a further enhancement, the mail server implements a mailing list to which the endpoints may subscribe for receiving software packages according to a predefined policy.

In an advantageous embodiment, an e-mail message with an indication of the result of the application of the software package is returned to the distribution server.

A suggested implementation also allows adding further feedback information (collected on the endpoint) to the returned e-mail message.

A possible example of the feedback information includes configuration information of the endpoint.

Another aspect of the invention proposes a computer program for performing the method.

A further aspect of the invention proposes a corresponding system.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

The invention itself, as well as further features and the advantages thereof, will be best understood with reference to the following detailed description, given purely by way of a non-restrictive indication, to be read in conjunction with the accompanying drawings, in which:

FIG. 1a is a schematic block diagram of a data processing system in which the solution according to an embodiment of the invention is applicable;

FIG. 1b shows the functional blocks of an exemplary computer of the system;

FIG. 2 depicts the main software components that can be used to practice the solution according to an embodiment of the invention; and

FIGS. 3a-3b show a diagram describing the flow of activities relating to an implementation of the solution according to an embodiment of the invention.

### DETAILED DESCRIPTION

The particular values and configurations discussed in these non-limiting examples can be varied and are cited merely to illustrate at least one embodiment and are not intended to limit the scope of such embodiments.

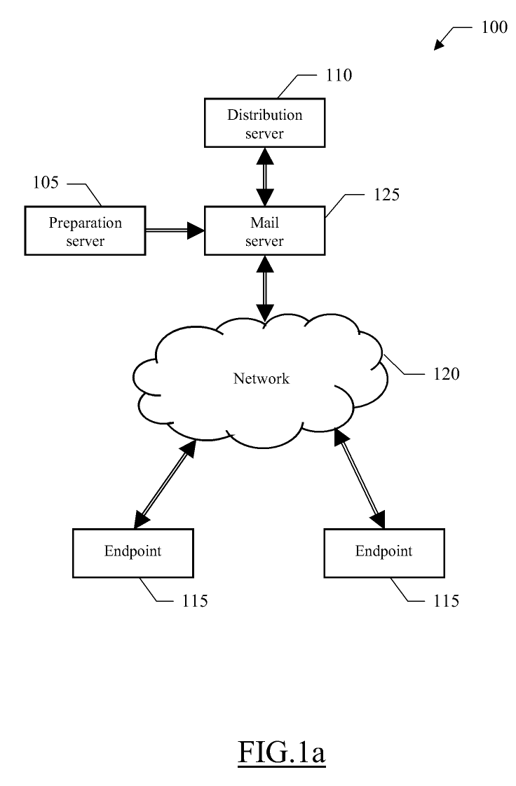

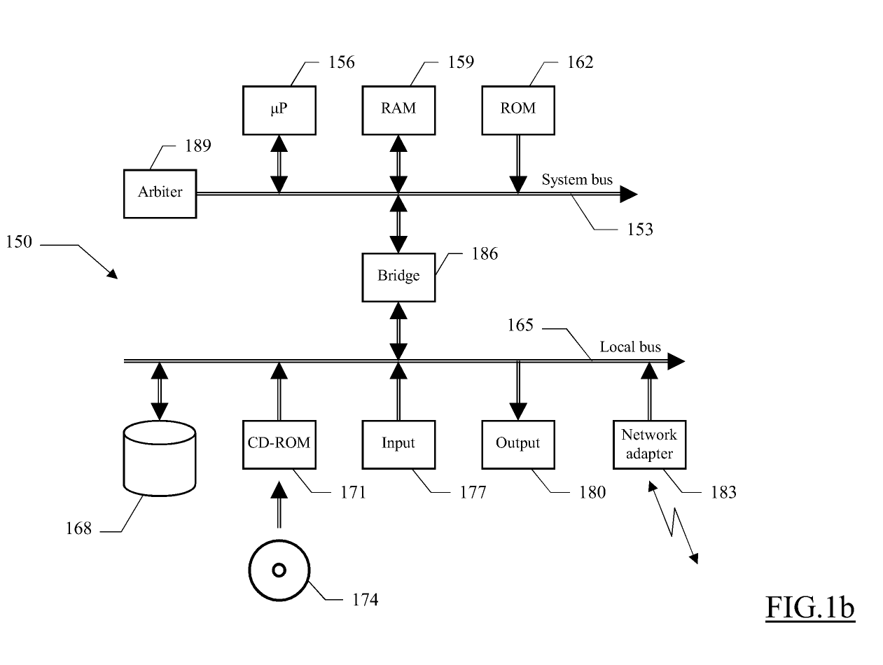

With reference in particular to FIG. 1a, a data processing system 100 with distributed architecture is illustrated. The system 100 implements a software distribution infrastructure (e.g., based on the above-mentioned “ITCM”).

Particularly, a preparation server 105 operates as a central site for defining and testing software packages to be used for enforcing desired software products, such as application programs (e.g., to install, upgrade, configure, or remove them). Generally, each software package (also known as software package block or “SPB”) consists of a file, for example, with the extension “.spb”. The software package starts with a header including different attributes thereof, such as its name, version, and the like. The software package then includes an action section that defines actions, possibly conditioned to run-time parameters, to be executed for its application; moreover, the software package includes a data section that contains an image of any required resources (such as executable modules, configuration files, databases, icons, and the like). The application of the software package causes the reaching of a desired target state of the software product (such as installed, removed, and so on).

A distribution server 110 controls the actual software distribution process. Particularly, the distribution server 110 deploys selected software packages from the preparation server 105 (acting as a source host) to multiple endpoints 115. For this purpose, the endpoints 115 are connected to a network 120 (such as a LAN).

This infrastructure facilitates the distribution of the software products (especially when the system 100 includes a high number of endpoints 115); moreover, all the operations can be controlled centrally from the distribution server 110. An example of such software distribution infrastructure (and particularly of the supported software packages) is described in WO-A-003085513, the entire disclosure of which is herein incorporated by reference.

As described in detail in the following solution, according to an embodiment of the invention, the software packages are distributed to the desired endpoints 115 by means of an electronic mail (e-mail) message service. Particularly, the process is implemented by a mail server 125, which is controlled by the distribution server 110. For this purpose, the mail server 125 receives the required software packages from the preparation server 105. The software packages are embedded into e-mail messages, which are then delivered to the endpoints 115 through the network 120 (for their application).

Generally speaking, an e-mail message (or simply e-mail) consists of a note that is transmitted from a sender to a receiver (identified by corresponding e-mail addresses) over a communication network. The e-mail message is formed by text and/or images; moreover, it is also possible to add one or more attachments consisting of external files. Communication by means of e-mail messages is very fast, flexible and reliable. Some (private) e-mail message services are used to exchange information within a specific organization, such as a company; however, the e-mail message services have become very popular in the last years thanks to the widespread diffusion of the Internet, which allow users to communicate anywhere in the world.

The format of the e-mail messages over the Internet is defined by the Multipurpose Internet Mail Extensions (MIME) standard. Briefly, an (Internet) e-mail message consists of a header section and a body section (separated by a blank line). The header section specifies different information about the e-mail message; each header consists of a name/value pair (separated by a “:”). For example, the header section usually includes an identification of the sender (“From:”), an identification of at least one receiver, possibly in the form of a distribution list (“To:”), a summary of its content (“Subject:”) and a corresponding date and time (“Date:”); other headers may indicate carbon copy receivers (“Cc:”) or blind carbon copy receivers (“Bcc:”), the names of any files attached to the e-mail message (“Attachment:”), its type of display (“Content-Type:”), and the like. On the other hand, the body section includes the actual (text/image) information to be transmitted to each receiver; typically, the body section ends with a signature of the sender.

The transmission of the e-mail messages is managed by corresponding mail servers. Particularly, any user sends each outgoing e-mail message (once formatted according to the MIME standard) to an associated mail server by means of the Simple Mail Transfer Protocol (SMTP). For example, this operation is performed by an Internet Service Provider (ISP) used by the sender to access the Internet, or by a gateway that bridges between a private e-mail service accessible to the sender and the Internet. The mail server in turn extracts the e-mail addresses of the receivers (from the SMTP protocol and not from the header section) to which the e-mail message must be delivered; each e-mail address consists of a personal username in a specific context, which is identified by a symbolic domain name (separated by the symbol “@”). The mail server exploits a system of Domain Name Servers (DNS) of the Internet to convert the domain name of each receiver into the physical location of the corresponding mail server, to which the e-mail message is then transmitted (using the SMTP protocol). All the e-mail messages received by any user are stored in a corresponding electronic mailbox on his/her mail server. The user can fetch the received e-mail messages from the mailbox into a local inbox by means of the Post Office Protocol (POP3).

The idea of exploiting the e-mail service for distributing the software packages avoids the need of installing any dedicated deployment service; therefore, the setup of the corresponding infrastructure is not required any longer. Conversely, the ubiquity of the e-mail service allows implementing the software distribution process in whatever scenario (minimizing the corresponding investment).

As a result, the complexity of the system is strongly reduced. Indeed, no additional computers (or a very low number) are required; in any case, the endpoints are generally already correctly configured to send/receive e-mail messages. Therefore, the maintenance of the whole software distribution infrastructure is strongly simplified (especially in a highly dynamic environment).

As a result, the impact on the endpoints is minimized. This has a beneficial effect on their performance; moreover, the proposed solution is now well suited to whatever applications (even subjected to strict security requirements).

All of the above fosters the widespread diffusion of the software distribution applications. As a result, it is possible to reduce the management costs and to improve the reliability of any data processing system.

Considering now FIG. 1b, a generic computer of the above-described system (preparation server, distribution server, endpoint, or mail server) is denoted with 150. The computer 150 is formed by several units that are connected in parallel to a system bus 153 (with a structure that is suitably scaled according to the actual function of the computer 150 in the system). In detail, one or more microprocessors (μP) 156 control operation of the computer 150; a RAM 159 is directly used as a working memory by the microprocessors 156 and a ROM 162 stores basic code for a bootstrap of the computer 150. Several peripheral units are clustered around a local bus 165 (by means of respective interfaces). Particularly, a mass storage consists of one or more hard-disks 168 and drives 171 for reading CD-ROMs 174. Moreover, the computer 150 includes input units 177 (e.g., a keyboard and a mouse), and output units 180 (e.g., a monitor and a printer). An adapter 183 is used to plug the computer 150 into the system. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

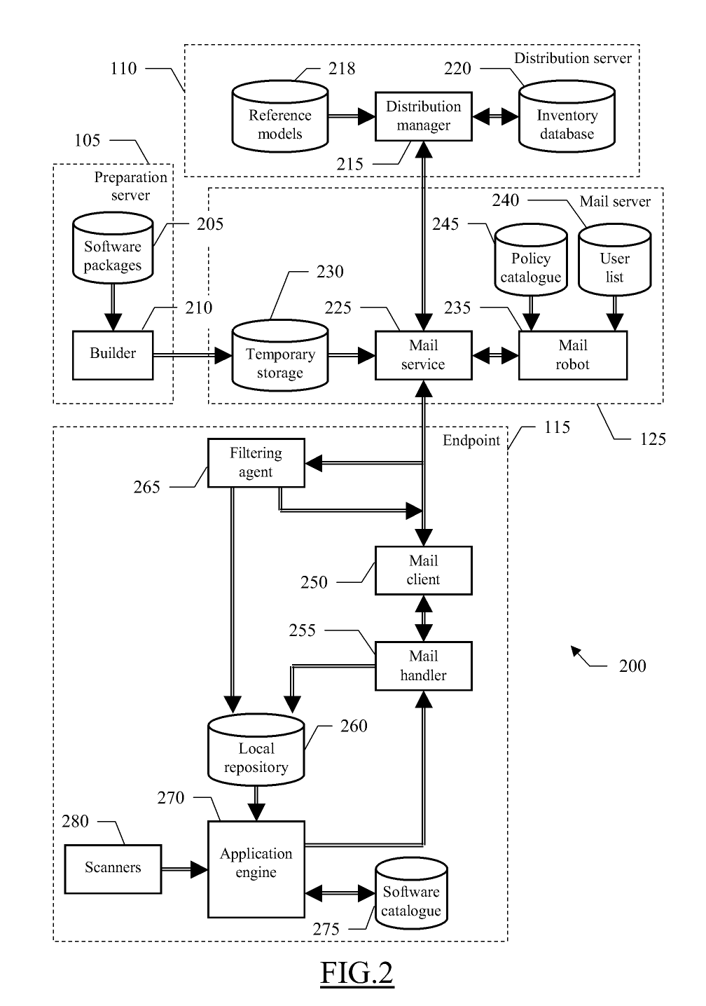

Moving to FIG. 2, the main software components that run on the above-described system are denoted as a whole with the reference 200. The information (programs and data) is typically stored on the hard-disk and loaded (at least partially) into the working memory of each computer when the programs are running. The programs are initially installed onto the hard disk, for example, from CD-ROM.

With reference in particular to the preparation server 105, the software packages or their definitions (together with the corresponding resource images) are stored into a repository 205. The repository 205 is accessed by a builder 210, which retrieves or dynamically generates selected software packages on demand.

The distribution server 110 runs a distribution manager 215, which exports different functionalities. For example, the distribution manager 215 may generate distribution plans consisting of lists of activities (each one specified by the desired target state of a software package) to be executed on selected endpoints; the distribution plans are then submitted to a planner (such as the “Activity Planner Manager or APM” service of the above-mentioned “ITCM”), which controls the execution of the corresponding activities. Particularly, the distribution plans are generated in a disconnected mode by a dedicated service (such as the “Change Manager or CM” of the “ITCM”), according to predefined reference models available in a corresponding repository 218. Each reference model specifies the desired software configuration (i.e., the target state of a set of software packages) for the endpoints subscribing to the reference model; those endpoints are identified according to their role (e.g., defined statically or dynamically by a category of users, by a department, by hardware/software features, and the like). Alternatively, the distribution plans are generated at run-time in response to specific requests entered through a Command Line Interface (“CLI”) so as to distribute selected software packages manually to a set of endpoints at a time. At the end, a web interface (such as the “WebUI” service of the “ITCM”) is used to publish particular software packages, which can then be downloaded in pull mode by authorized users of the endpoints.

The distribution manager 215 controls an inventory database 220, which stores (software and/or hardware) configuration information of all the endpoints of the system. For example, for each endpoint the inventory database 220 specifies an actual state of the software packages that have been distributed to the endpoint (i.e., whether they have been correctly applied so as to reach the desired target state); moreover, the inventory database 220 may also list any exposure of the endpoint to problems caused by missing patches that are available for the software products installed thereon. The inventory database 220 may also provide different hardware parameters of the endpoint (such as its processor type, memory size, and the like). The configuration information available in the inventory database 220 is used by the distribution manager 215 to synchronize the endpoints with their reference models, to plan the deployment of required patches, and so on.

Moving now to the mail server 125, a corresponding service 225 implements the actual distribution of the software packages to the desired endpoints. For this purpose, the mail service 225 receives each required software package from the builder 210 and saves it into a temporary storage 230. The mail service 225 creates a corresponding e-mail message, which embeds the software package as an attachment. The mail service 225 also adds specific tags (for controlling the software distribution process) to the body section of the e-mail message. Typically, the control tags specify the target state of the embedded software package; in addition, the control tags may indicate that feedback information must be returned from the endpoints (e.g., indicating a result of the application of the software package, an actual configuration of each endpoint, and the like). The mail service 225 then transmits the e-mail message to the desired endpoints. The mail service 225 also receives any e-mail messages returned from the endpoints; in this case, the mail service 225 extracts the received feedback information and forwards it to the distribution manager 215 (for updating the inventory database 220). In this way, it is possible to notify the result of the operation promptly to an administrator of the system. Moreover, the possibility of selecting the feedback information to be returned (by means of the control tags) makes the proposed solution very flexible.

Typically, operation of the mail service 225 is controlled by the distribution manager 215. This ensures a complete integration of the proposed solution within the software distribution infrastructure.

Moreover, the mail service 225 may also interface with a mail robot 235 (e.g., based on the “Majordomo” program). As it will be apparent in the following, the mail robot 235 implements an automatic answering system. In this case, the mail robot 235 exposes a specific e-mail address that may be used by the different endpoints to submit e-mail messages including specific requests (such as the installation or the removal of a selected software product, the synchronization with a selected reference model, and the like). The mail robot 235 processes the received e-mail messages and distributes the required software packages as in the preceding case. This embodiment of the invention adds further flexibility to the proposed solution.

In addition or in alternative, the mail robot 235 manages a mailing list. Generally speaking, a mailing list consists of a service that is used to broadcast e-mail messages automatically. For this purpose, each user subscribes to the mailing list by sending an e-mail message with a predefined content to a specific e-mail address; in this way, the user is registered (with his/her e-mail address extracted from the subscription e-mail message) into the mailing list. A similar procedure is used to unsubscribe from the same mailing list. Whenever an e-mail message is submitted to another e-mail address of the mailing list (distinct from the one used to subscribe/unsubscribe), that e-mail message is automatically forwarded to the e-mail addresses of all the registered users.

In the specific situation, the users of the endpoints can only subscribe to (or unsubscribe from) the mailing list managed by the mail robot 235; each subscribing user may also indicate specific requests as in the preceding case (e.g., the maintenance up-to-date of a selected software product, the subscription to a selected reference model, and the like). The users registered in the mailing list (together with their e-mail addresses and any specific requests) are stored into a list 240 that is maintained by the mail robot 235. The mail robot 235 broadcasts (through the mail service 225) e-mail messages embedding the desired software packages to the e-mail addresses extracted from the registered user list 240. For this purpose, the mail robot 235 also accesses a catalogue 245, which defines a specific policy for controlling the deployment of the software packages to the registered users; examples of this policy includes the delivery of each (approved) new patch to all the endpoints wherein the corresponding software product is installed, the synchronization with each reference model by all the subscribing endpoints whenever a change occurs in its definition, and the like. In this case, it is possible to implement any desired strategy for distribution the software products in a completely automatic.

Considering now a generic endpoint 115, a mail client 250 is used to create, send, receive, display, and save e-mail messages; an example of a commercial mail client 250 available on the market is “Lotus Notes” by IBM Corporation. In the solution according to an embodiment of the invention, a dedicated plug-in 255 is added to the mail client 250 for handling the e-mail messages relating to the software distribution process. The mail handler 255 processes those e-mail messages by extracting the software packages and the control tags embedded therein; the corresponding information is then saved into a local repository 260.

In addition or in alternative, a filtering agent 265 intercepts all the e-mail messages that are downloaded onto the endpoint 115 (e.g., using a hooking technique). The filtering agent 265 automatically extracts the software packages and the control tags from the e-mail messages relating to the software distribution process and then saves the corresponding information into the same local repository 260; the other (standard) e-mail messages are, instead, forwarded to the mail client 250 for their display.

The local repository 260 is accessed by an application engine 270 (such as the “Software Installation Engine or SIE” service of the “ITCM”), which enforces their application on the endpoint 115. The application engine 270 also controls a software catalogue 275, which stores a current state of all the software packages that were applied on the endpoint 115. More in detail, for each software package (in the local repository 260) that is not yet in the desired target state (as indicated in the software catalogue 275), the application engine 270 causes the execution of the corresponding actions required to reach this target state and then updates the software catalogue 275 according to the result of the operation. The application engine 270 also interfaces with a set of (one or more) scanners 280, which are used to collect configuration information of the endpoint 115; for example, the scanners 280 may be used to determine the software products that are actually installed on the endpoint 115, the patches that should be required, its hardware parameters, and so on. The application engine 270 returns any required feedback information (e.g., the result of the application of the software package, selected configuration information of the endpoint 115, and the like) to the mail handler 255. The mail handler 255 creates a new e-mail message, which embeds this feedback information; the e-mail message is then passed to the mail client 250 for its transmission to the mail service 225.

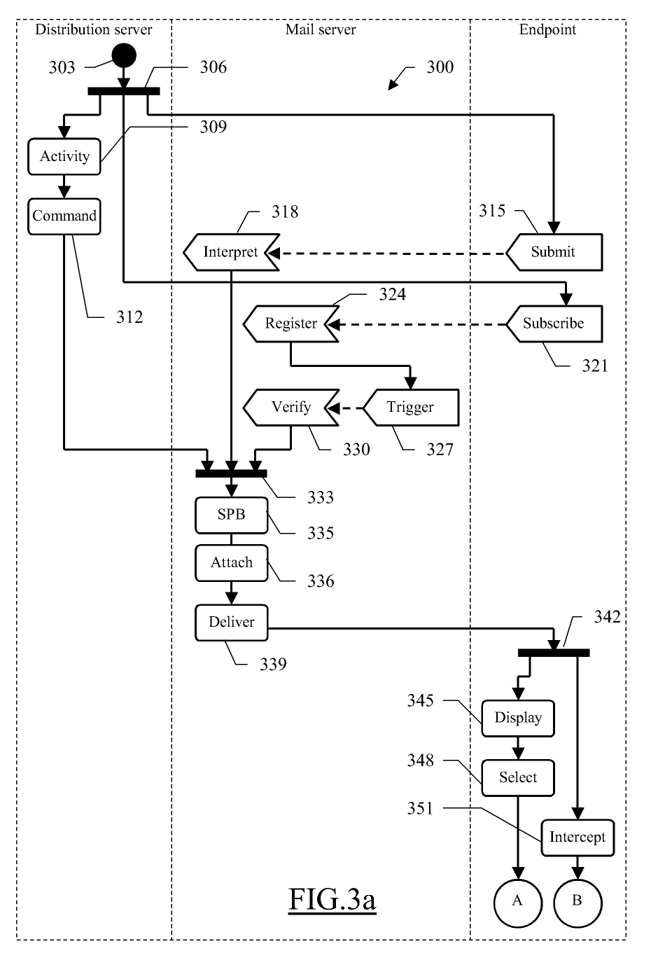

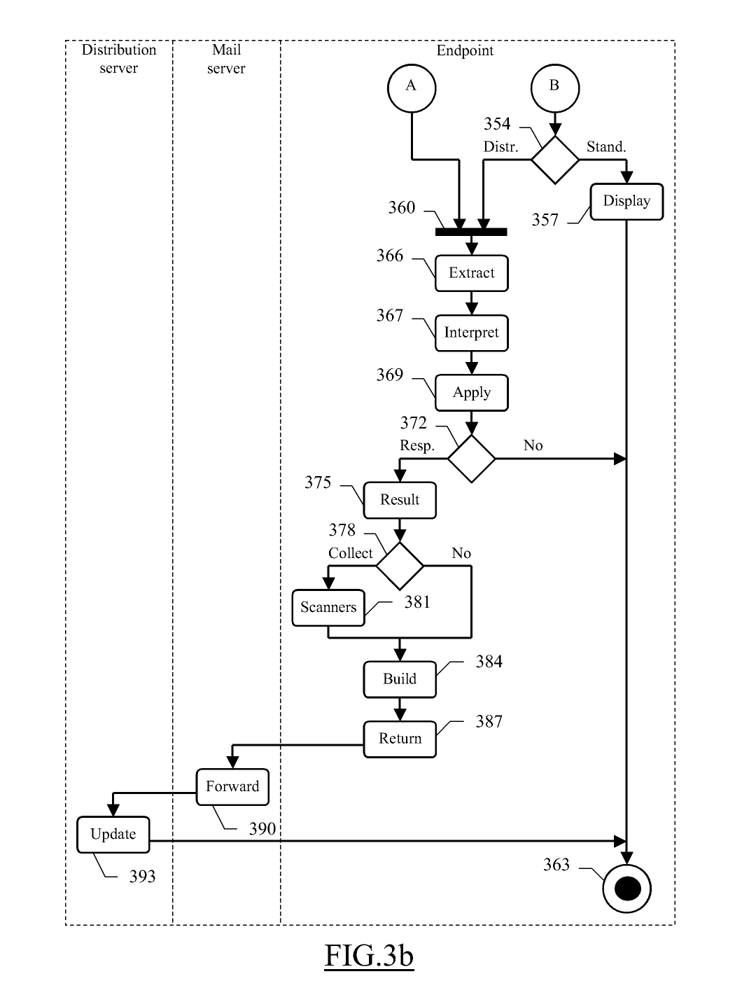

As shown in FIGS. 3a-3b, the logic flow of an exemplary process that can be implemented in the above-described system to distribute a generic software product is represented with a method 300. The method 300 starts at block 303 in the swim-lane of the distribution server. The flow of activity then forks at the synchronization bar 306 into alternative branches. Particularly, an implementation involves the execution of the branch formed by the blocks 309-312, another implementation involves the execution of the branch formed by the blocks 315-318, and a further implementation involves the execution of the branch formed by the blocks 321-330; the three branches joint at the further synchronization bar 333.

Considering now block 309, a specific activity of the software distribution process is processed; for example, the activity results from the submission of a distribution plan, from a request entered through the command line interface or from a downloading invocation. In any case, a corresponding command is transmitted from the distribution server to the mail server at block 312; this command specifies the software package to be deployed, its target state, the list of endpoints on which the software package must be applied, and any additional operation to be performed on them. The branch ends at the synchronization bar 333.

In another embodiment of the invention, the user of a generic endpoint submits an e-mail message with a specific request to the mail server at block 315 (such as requiring the installation or the removal of a selected software product, the synchronization with a selected reference model, and the like). Continuing to block 318, the mail robot parses the body section of the received e-mail message and interprets the submitted request; as a result, the mail robot transmits corresponding commands to the mail service. For example, the submitted request may involve the deployment of a selected software package, of a set of software packages required to synchronize the endpoint with a selected reference model, and the like. The branch then ends at the synchronization bar 333.

On the other hand, in a further embodiment of the invention the user of the endpoint at block 321 sends an e-mail message to the mail server for subscribing to the mailing list managed by the mail robot; typically, this e-mail message also includes specific requests, such as the maintenance up-to-date of a selected software product, the subscription to a selected reference model, and the like. In response thereto, the mail robot at block 324 registers the user in the mailing list (by adding the relevant information into the registered user list). In response to a triggering event, the process now passes from block 327 to block 330; examples of this triggering event are a simple time-out (such as every 1-2 hours), the delivery of a new software product or a new version thereof, the availability of a new patch, any change in the reference models, and the like. In this phase, the mail robot determines the operations to be performed (according to the content of the registered user list and of the policy catalogue); for example, a software package for installing a new version of a software product or a corresponding patch must be deployed to all the endpoints wherein the product must be maintained up-to-date, a set of software packages for synchronizing selected endpoints with the respective reference model must be deployed thereto, and the like. The mail robot then transmits the corresponding commands to the mail service. The branch now ends at the synchronization bar 333.

In any case, the method 300 then passes from the synchronization bar 333 to block 335. In response to the received commands, the mail service fetches the required software packages from the preparation server. Continuing to block 336, the corresponding e-mail messages are created; each e-mail message embeds the software package to be deployed as an attachment, with the required control tags in its body section (specifying the target state of the software package and possibly the request of returning feedback information, such as indicating the result of the application of the software package or the actual configuration of the endpoint). Descending into block 339, the mail service delivers the e-mail message to the desired endpoints.

Moving now to the swim-lane of a generic endpoint, the flow of activity forks at the synchronization bar 342 into two branches that are executed alternatively according to the implementation of the invention that has been chosen. Particularly, an implementation involves the execution of the branch formed by the blocks 345-348, whereas another implementation involves the execution of the branch formed by the blocks 351-357; the two branches joint at the further synchronization bar 360 or at the concentric white/black stop circles 363.

Considering now block 345, when all the e-mail messages are received by the mail client directly, each e-mail message is displayed as usual. Whenever an e-mail message relating to the software distribution process is received, the user at block 348 can select the attached software package (e.g., by double-clicking with the mouse on it); in this case, the mail handler recognizes the software package (according to the specific extension “.spb”) and causes its processing (as described in the following). The branch then ends at the synchronization bar 360. This implementation is very simple and of general applicability.

Alternatively, when the filtering agent is installed, all the e-mail messages that are downloaded onto the endpoint are intercepted at block 351. The filtering agent then introspects each intercepted e-mail message at block 354. If the e-mail message relates to the software distribution process (i.e., it includes an attachment with the extension “.spb”), the method 300 descends into the synchronization bar 360; this causes the processing of the corresponding software package and the e-mail message is automatically removed from the inbox of the mail client (so as to be hidden to the user of the endpoint). Conversely, the flow of activity passes from the decision block 354 to block 357; as a result, the (standard) e-mail message is forwarded to the mail client for its display as usual. The process then ends at the stop circles 363. In this case, the software distribution process is completely opaque to the operation of the mail client.

Referring back to the synchronization bar 360, in both cases the method 300 now descends into block 366. In this phase, the mail handler extracts the software package from the e-mail message and saves it into the local repository. Continuing to block 367, the body section of the same e-mail message is parsed and each control tag included therein is interpreted; corresponding commands (in a format suitable to be processed by the application engine) are then added to the entry of the software package in the local repository. Proceeding to block 369, the application engine applies each software package in the local repository, in an attempt to reach the desired target state indicated in the same entry of the local repository; at the same time, the software catalogue is updated accordingly.

The method 300 then branches at the decision block 372. For each applied software package, if no feedback information was required (in the body section of the respective e-mail message) the flow of activity passes to the stop circles 363 directly. Conversely, the result of the application of the software package is extracted from the software catalogue at block 375. A test is now made at block 378 to determine whether it is necessary to collect configuration information of the endpoint. If so, the relevant scanners are invoked at block 381 (e.g., to determine the software products that are actually installed on the endpoint, the patches that should be required, its hardware parameters, and the like); the process then continues to block 384. The same point is also reached from block 378 directly when the body section of the e-mail message used to deploy the software package did not include any control tag requesting the collection of configuration information.

Considering now block 384, the mail handler creates a new e-mail message; the required feedback information is then embedded into its body section (in a format suitable to be processed by the mail service). This e-mail message is then sent at block 387 to the mail server. In response thereto, the mail service at block 390 parses the body section of the received e-mail message and interprets its content so as to extract the feedback information. The feedback information is then converted into a format suitable to be processed by the distribution manager and forwarded to the distribution server. The distribution manager at block 393 receives this feedback information and updates the inventory database accordingly. The process then ends at the stop circles 363.

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, similar considerations apply if the system has a different architecture or includes equivalent units (e.g., with the distribution server, the preparation server and/or the mail server that are consolidated into a single computer). Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

Although in the preceding description reference has been made to a specific software distribution application, this is not to be intended as a limitation (with the service deployed by the software distribution infrastructure that is suitable to be controlled by any other provider). Likewise, the software packages may have a different structure, may be used to distribute equivalent software products (such as multimedia works) or may support different target states (such as installed in an undoable manner, installed and committed, and so on).

The same applies to other mail services, even based on different protocols and/or formats (such as the “X.400” or any proprietary solution); in any case, the e-mail messages may be managed by different (fat) mail clients or through a “webmail” interface directly. It is also possible to add further features to increase the security of the proposed solution (e.g., by encrypting the software packages or by using a “Secure Sockets Layer or SSL” protocol to transmit the e-mail messages). Moreover, it should be readily apparent that either the software package and/or the control tags may be embedded into the e-mail message in whatever other way (such as by encoding the desired target state in its subject); similar considerations apply when each e-mail message includes two or more software packages (with either general control tags for all the software packages or specific control tags for each one of them).

Nothing prevents the implementation of the desired operations by the mail client directly (without any additional plug-in); in addition, it is also possible to automate the selection of the attachments including the software packages for their processing by the application engine.

Similar considerations apply if the incoming e-mail messages are intercepted with an equivalent technique or if the e-mail messages relating to the software distribution process are identified in another way (e.g., by means of predefined keywords in their body sections, such as in the subjects).

In both cases, the extraction of the software package and of the control tags from the e-mail message, and/or the interpretation of the control tags may be performed directly by the application engine (or by a dedicated plug-in).

Without detracting from the principles of the invention, the distribution manager may operate only in some of the above-described modes or even in different ones, or it may submit any equivalent request to the mail server. Moreover, nothing prevents the implementation of the mail service directly by the distribution manager.

Similar considerations apply if the requests are submitted to the mail robot in a different way (e.g., with e-mail messages having a predefined subject) or if any other requests are supported

Alternatively, a different mailing list may be implemented by the mail robot (e.g., based on the LISTSERV program); in addition, it is possible to manage the mailing list according to other policies (e.g., defining allowable time windows for delivering the e-mail messages embedding the software packages).

In any case, the proposed techniques for controlling the mail service may also be implemented in combination. Vice versa, the solution according to the present invention lends itself to be put into practice with some of those techniques only (e.g., exclusively under the control of the distribution server).

Nothing prevents returning the results of the application of the software package to the distribution sever in a different manner (e.g., by means of an e-mail message directly addressed to it or by means of an instant message); moreover, it is also possible to skip this step in a basic implementation of the invention.

It is also within the scope of the invention the possibility of collecting different information on the endpoints (such as about the settings of the installed software products). In this case as well, the proposed feature is not strictly necessary and it may be omitted in some implementations.

Similar considerations apply if the program (which may be used to implement each embodiment of the invention) is structured in a different way or if additional modules or functions are provided; likewise, the memory structures may be of other types or may be replaced with equivalent entities (not necessarily consisting of physical storage media). Moreover, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code). Moreover, the program may be provided on any computer-usable medium; the medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, the solution according to the present invention lends itself to be carried out with a hardware structure (e.g., integrated in a chip of semiconductor material) or with a combination of software and hardware.

It will be appreciated that variations of the above-disclosed and other features and functions, or alternatives thereof may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for distributing software products in a data processing system including a plurality of target entities reachable through at least one electronic mail server, said method comprising:
providing a software package adapted to enforce a set of predefined target states of a software product;
delivering a service electronic mail message through said at least one mail server to a set of target entities, said service message including said software package and an indication of a selected target state of said corresponding software product;
an agent extracting said software package and said indication of said selected target state from said service message on each target entity; and
applying said software package on each target entity to enforce said selected target state of said software product on said target entity.

2. The method of claim 1 further comprising, for each target entity:
displaying said service message by an electronic mail client;
selecting an attachment of said service message including said software package; and
said agent causing said extraction and said application of said software package by a software distribution engine in response to said selection.

3. The method of claim 1 further comprising for each target entity under said control of said agent:
intercepting each electronic mail message received on said target entity;
verifying said inclusion of said software package in each received message; and
causing said extraction and said application of said software package by a software distribution engine in response to said inclusion, or causing said display of said received message by an electronic mail client otherwise.

4. The method of claim 1 further comprising:
submitting a software distribution request including an indication of said software package, of said selected target state, and of said set of target entities by a software distribution server of said system to said at least one mail server, said service message being delivered to said set of target entities in response to said software distribution request.

5. The method of claim 1, further comprising, for at least one target entity:
submitting a request electronic mail message including an indication of said software package and of said selected target state by said target entity to said at least one mail server, said at least one mail server delivering said service message to said target entity in response to said request message.

6. The method of claim 1 further comprising:
at least one target entity subscribing to an electronic mailing list managed by said at least one mail server; and
said at least one mail server delivering said service message to each subscribing target entity according to a predefined policy.

7. The method of claim 4 further comprising for at least one target entity:
returning a response electronic mail message to said software distribution server through said at least one mail server, said response message including an indication of a result of said application of said software package on said target entity.

8. The method of claim 1 wherein said service message further includes an indication of feedback information to be returned to said software distribution server, said method further including:
collecting said feedback information on said target entity; and
embedding said feedback information into said response message.

9. The method of claim 9 wherein said feedback information includes configuration information of said target entity.

10. A system for distributing software products in a data-processing environment including a plurality of target entities reachable through at least one electronic mail server, said system comprising:
a processor;
a data bus coupled to said processor; and
a computer-usable medium embodying computer code, said computer-usable medium being coupled to said data bus, said computer program code comprising instructions executable by said processor and configured for:
providing a software package adapted to enforce a set of predefined target states of a software product;
delivering a service electronic mail message through said at least one mail server to a set of target entities, said service message including said software package and an indication of a selected target state of said corresponding software product;
an agent extracting said software package and said indication of said selected target state from said service message on each target entity; and
applying said software package on each target entity to enforce said selected target state of said software product on said target entity.

11. The system of claim 10 wherein for each target entity, said instructions are further configured for:
displaying said service message by an electronic mail client,
selecting an attachment of said service message including said software package, and
said agent causing said extraction and said application of said software package by a software distribution engine in response to said selection.

12. The system of claim 10 wherein for each target entity under said control of said agent, said instructions are further configured for:
intercepting each electronic mail message received on said target entity,
verifying said inclusion of said software package in each received message, and
causing said extraction and said application of said software package by a software distribution engine in response to said inclusion, or causing said display of said received message by an electronic mail client otherwise.

13. The system of claim 10 wherein said instructions are further configured for:
submitting a software distribution request including an indication of said software package, of said selected target state, and of said set of target entities by a software distribution server of said system to said at least one mail server, said service message being delivered to said set of target entities in response to said software distribution request.

14. The system of claim 10 wherein for at least one target entity, said instructions are further configured for:
submitting a request electronic mail message including an indication of said software package and of said selected target state by said target entity to said at least one mail server, said at least one mail server delivering said service message to said target entity in response to said request message.

15. The system of claim 10 wherein said instructions are further configured for:
at least one target entity subscribing to an electronic mailing list managed by said at least one mail server, and
said at least one mail server delivering said service message to each subscribing target entity according to a predefined policy.

16. The system of claim 10 wherein said service message further includes an indication of feedback information to be returned to said software distribution server, said method further including:
collecting said feedback information on said target entity, and
embedding said feedback information into said response message.

17. A computer-usable medium embodying computer program code for distributing software products in a data processing system including a plurality of target entities reachable through at least one electronic mail server, said computer program code comprising computer executable instructions configured for:
providing a software package adapted to enforce a set of predefined target states of a software product;
delivering a service electronic mail message through said at least one mail server to a set of target entities, said service message including said software package and an indication of a selected target state of said corresponding software product;
an agent extracting said software package and said indication of said selected target state from said service message on each target entity; and
applying said software package on each target entity to enforce said selected target state of said software product on said target entity.

18. The computer-usable medium of claim 17 wherein for each target entity, said embodied computer program code further comprises computer executable instructions configured for:
displaying said service message by an electronic mail client;
selecting an attachment of said service message including said software package; and
said agent causing said extraction and said application of said software package by a software distribution engine in response to said selection.

19. The computer-usable medium of claim 17 wherein for each target entity under said control of said agent, said embodied computer program code further comprises computer executable instructions configured for:
intercepting each electronic mail message received on said target entity;
verifying said inclusion of said software package in each received message; and
causing said extraction and said application of said software package by a software distribution engine in response to said inclusion, or causing said display of said received message by an electronic mail client otherwise.

20. The computer-usable medium of claim 17 wherein said embodied computer program code further comprises computer executable instructions configured for:
at least one target entity subscribing to an electronic mailing list managed by said at least one mail server; and
said at least one mail server delivering said service message to each subscribing target entity according to a predefined policy.
